(19) United States
(12) Patent Application Publication
(10) Pub. No.: US 2009/0112433 A1
(43) Pub. Date: Apr. 30, 2009

(54) METHOD FOR CONTROLLING VALVE IN ELECTRONIC HYDRAULIC PRESSURE CONTROL SYSTEM

(75) Inventor: Man Bok PARK, Gangnam-gu (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/259,968

(22) Filed: Oct. 28, 2008

(30) Foreign Application Priority Data
Oct. 29, 2007 (KR) 10-2007-108817

(51) Int. Cl. B60T 7/12

(52) U.S. Cl. 701/71

(57) ABSTRACT

Disclosed is a method for controlling a valve in an electronic hydraulic pressure control system, capable of effectively controlling the valve such that differential pressure between a master cylinder and a wheel cylinder is constantly maintained. The method includes the steps of measuring pressure of the master cylinder, measuring pressure of the wheel cylinder, and controlling on/off operation of the valve based on a current value obtained according to the differential pressure between the master cylinder and the wheel cylinder.

This application claims the benefit of Korean Patent Application No. 10-2007-0108817 filed on Oct. 29, 2007, in the Korean Intellectual Property Office, the disclosure of which is incorporated herein by reference.

### BACKGROUND OF THE INVENTION

1. Field of the Invention

The present invention relates to a method for controlling a valve in an electronic hydraulic pressure control system. More particularly, the present invention relates to a method for controlling a valve in an electronic hydraulic pressure control system to constantly maintain differential pressure between a master cylinder and a wheel cylinder.

2. Description of the Related Art

In general, a hydraulic brake system of a vehicle is equipped with an ABS (Anti-lock Brake System), an ESP (Electronic Stability Program), and TCS (Traction Control System) for preventing wheels from slipping upon a braking operation, thereby improving performance of a brake device of the vehicle.

The ABS, ESP and TCS adjust pressure of a wheel cylinder according to pressure of a master cylinder, the state of road, a vehicle speed, and the like to control a slip of the vehicle and a vehicle posture.

The hydraulic brake system of the vehicle includes a master cylinder connected to a brake pedal and equipped with a pressure sensor, a wheel cylinder connected to front and rear wheels and equipped with a pressure sensor, and a plurality of solenoid valves for controlling hydraulic pressure supplied to the wheel cylinder. If the ABS, ESP and the TCS are not operated, the solenoid valves are not operated, so that differential pressure between the master cylinder and the wheel cylinder is constantly maintained. However, if the ABS, ESP and the TCS are operated, pressure of the master cylinder and the wheel cylinder may vary. If differential pressure between the master cylinder and the wheel cylinder is not uniform, the braking operation may not be normally operated and a driver may sense abnormal feeling when the driver steps on a pedal upon the braking operation.

### SUMMARY OF THE INVENTION

Accordingly, it is an aspect of the present invention to provide a method for controlling a valve in an electronic hydraulic pressure control system to constantly maintain differential pressure between a master cylinder and a wheel cylinder.

Additional aspects and/or advantages of the invention will be set forth in part in the description which follows and, in part, will be apparent from the description, or may be learned by practice of the invention.

The foregoing and/or other aspects of the present invention are achieved by providing a method for controlling a valve in an electronic hydraulic pressure control system, the method comprising measuring pressure of a master cylinder, measuring pressure of a wheel cylinder, and controlling on/off operation of the valve based on a current value obtained according to differential pressure between the master cylinder and the wheel cylinder.

The valve is controlled such that the valve is open according to an open model when the differential pressure between the master cylinder and the wheel cylinder is higher than predetermined reference differential pressure by a predetermined value or more. The valve is controlled such that the valve is dosed according to a close model when the differential pressure between the master cylinder and the wheel cylinder is lower than predetermined reference differential pressure by a predetermined value or more.

The open model represents a current value at a time point at which the valve is open according to the differential pressure between the master cylinder and the wheel cylinder.

The close model represents a current value at a time point at which the valve is closed according to the differential pressure between the master cylinder and the wheel cylinder.

As described above, according to the method for controlling the valve in the electronic hydraulic pressure control system, braking pressure of the wheel cylinder can be precisely adjusted by improving the control scheme for the valve in the hydraulic line upon braking operation.

In addition, the driver may not sense abnormal feeling when the driver steps on the pedal and hydraulic pressure can be precisely controlled.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a hydraulic circuit view of an electronic hydraulic pressure control system;

FIG. 2 is a graph showing an open model and a dose model;

FIG. 3 is a graph used for obtaining a feed-forward gain; and

FIG. 4 is a flowchart showing a procedure for controlling a valve in an electronic hydraulic pressure control system according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements. The embodiments are described below to explain the present invention by referring to the figures.

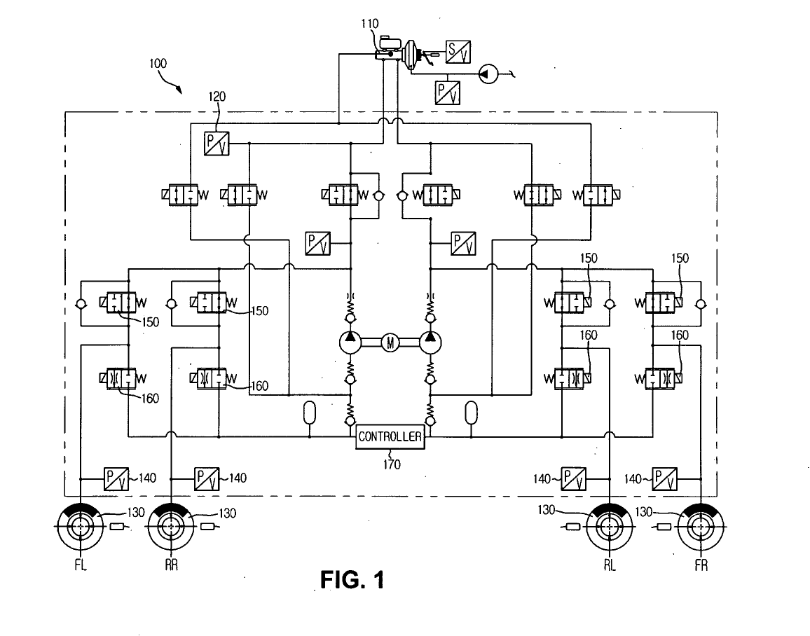

As shown in FIG. 1, an electronic hydraulic pressure control system 100 according to an embodiment of the present invention includes a master pressure sensor 120 for measuring pressure of a master cylinder 110, a wheel pressure sensor 140 for measuring pressure of a wheel cylinder 130, a plurality of inlet and outlet valves 150 and 160, and a controller 170 for controlling on/off operation of the inlet and outlet valves 150 and 160.

The operation of the hydraulic system is generally known in the art, so detailed description thereof will be omitted and the following description will be focused on the features of the present invention.

Hydraulic brake pressure is generated in the master cylinder 110 when the driver steps on the brake pedal, and the master pressure sensor 120 measures the hydraulic brake pressure of the master cylinder 110.

The hydraulic brake pressure of the master cylinder 110 is transferred to the wheel cylinder 130 through on/off operation of the inlet and outlet valves 150 and 160.

Preferably, normal open solenoid valves are generally used for the inlet valves 150, normal close solenoid valves are generally used for the outlet valves 160, and the controller 170 controls the on/off operation of the valves by using pressure measured from the master pressure sensor 120 and the wheel pressure sensor 140.

In more detail, the controller 170 adjusts current applied to the valves based on the pressure measured from the master pressure sensor 120 and the wheel pressure sensor 140 to control the valves. That is, the controller 170 controls the on/off operation of the valves 150 and 160 based on the current value obtained according to the differential pressure between the master cylinder 110 and the wheel cylinder 130.

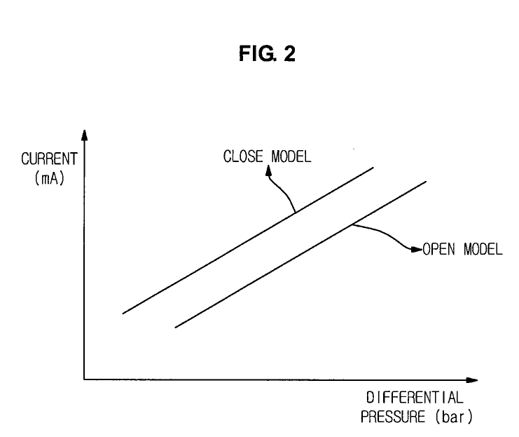

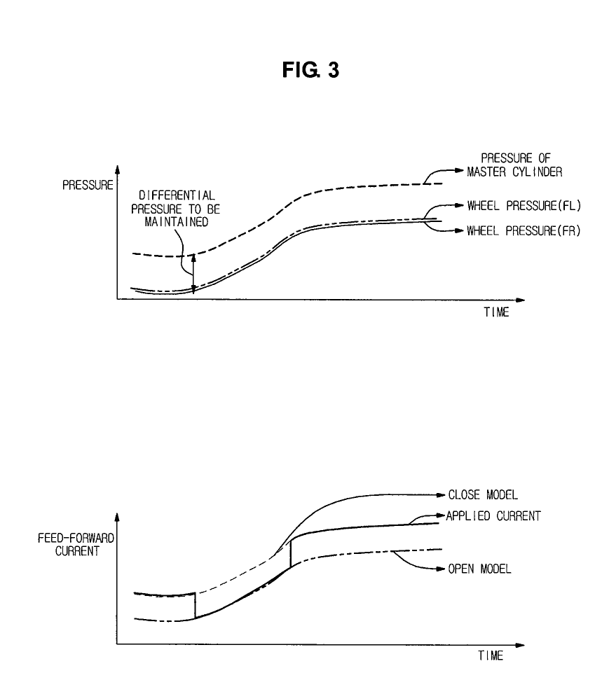

FIG. 2 is a graph showing an open model and a close model, and FIG. 3 is a graph used for obtaining a feed-forward gain.

Referring to FIGS. 2 and 3, the controller 170 controls the valves such that the valves are open according to an open model when the differential pressure between the master cylinder 110 and the wheel cylinder 130 is higher than predetermined reference differential pressure by a predetermined value or more.

In other words, if the differential pressure between the master cylinder 110 and the wheel cylinder 130 exceeds the predetermined reference differential pressure by the predetermined value or more, the controller 170 opens the inlet valves 150 to raise the pressure of the wheel cylinder 130. If the pressure of the wheel cylinder 130 is raised, the differential pressure between the master cylinder 110 and the wheel cylinder 130 is reduced, so that the differential pressure can be constantly maintained.

The term “open model” represents a current value at a time point at which the inlet valves 150 are open according to the differential pressure between the master cylinder 110 and the wheel cylinder 130. The open model can be obtained through the statistic scheme by using experimental data. The open model is represented in the form of a graph. In order to obtain the open model, the current value applied to the inlet valves 150 is lowered in a state in which the inlet valves 150 are closed to detect time points of opening the inlet valves 150 and the detection result is represented as the graph.

When controlling the pressure of the valves, the error is corrected through the feed-forward control and the feedback control. The feed-forward control is performed to correct the error according to an equation based on current and wheel pressure, and the feedback control is performed to correct the error between target pressure and actual pressure by using a PID controller.

In other words, the error between target wheel pressure TWP and wheel pressure WP measured by the wheel pressure sensor is corrected through a feedback gain, and the wheel pressure WP is compared with calculated wheel pressure MWP that is calculated using a predetermined equation to correct the error through the feed-forward gain, thereby correcting the wheel pressure.

Meanwhile, according to an embodiment of the present invention, the controller 170 controls the inlet valves 150 to constantly maintain the differential pressure. However, the present invention is not limited thereto. For instance, the controller 170 can control the outlet valves 160 to constantly maintain the differential pressure.

The controller 170 controls the valves such that the valves are dosed according to a dose model when the differential pressure between the master cylinder 110 and the wheel cylinder 130 is lower than predetermined reference differential pressure by a predetermined value or more.

The term “dose model” represents a current value at a time point at which the valves are dosed according to the differential pressure between the master cylinder 110 and the wheel cylinder 130. In other words, the close model represents the current value at a time point at which the differential pressure, which is constantly maintained before, is increased as the inlet valves 150 are switched from the open state to the dosed state.

In this manner, the controller 170 switches the inlet valves 150 from the open state into the closed state by using the close model to reduce the pressure of the wheel cylinder 130 such that differential pressure between the master cylinder 110 and the wheel cylinder 130 can be increased, thereby constantly maintaining the differential pressure.

In other words, the differential pressure between the master cylinder 110 and the wheel cylinder 130 is measured, the feed-forward gain is detected by using the open model and the close model according to the measured differential pressure, and remaining errors are corrected by using the feedback gain, thereby constantly maintaining the differential pressure with relatively high precision without causing the driver to sense abnormal feeling when the driver steps on the pedal upon braking operation.

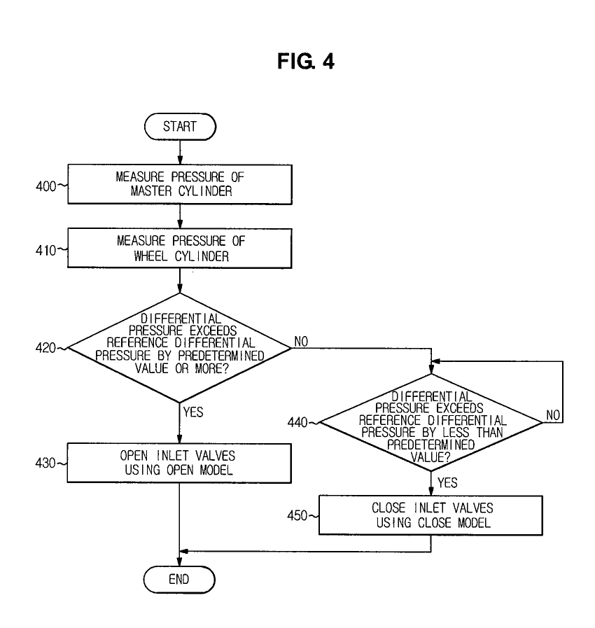

FIG. 4 is a flowchart showing a procedure for controlling the valves in the electronic hydraulic pressure control system according to an embodiment of the present invention. As shown in FIG. 4, the controller 170 measures the pressure of the master cylinder 110 (step 400).

Then, the controller 170 measures the pressure of the wheel cylinder 130 (step 410).

Next, the controller 170 compares the differential pressure between the master cylinder 110 and the wheel cylinder 130 with the predetermined reference differential pressure to determine whether the differential pressure between the master cylinder 110 and the wheel cylinder 130 exceeds the predetermined reference differential pressure by the predetermined value or more (step 420). If the differential pressure exceeds the predetermined reference differential pressure by the predetermined value or more, the controller 170 opens the valves by using the open model (step 430).

For instance, if the pressure of the master cylinder is 100 bar and the pressure of the wheel cylinder is 77 bar in a state in which the reference differential pressure is set to 20 bar and the predetermined value is set to 2 bar, the differential pressure between the master cylinder and the wheel cylinder is 23 bar. In this case, since the differential pressure (23 bar) exceeds the reference differential pressure (20 bar) more than the predetermined value (2 bar), the controller 170 opens the valves.

In this manner, the controller 170 controls the valves such that the valves are open when the differential pressure between the master cylinder and the wheel cylinder exceeds the reference differential pressure by the predetermined value or more. If the pressure of the wheel cylinder is increased, the differential pressure between the master cylinder and the wheel cylinder is reduced, so that the differential pressure can be constantly maintained.

In step 420, if the differential pressure between the master cylinder 110 and the wheel cylinder 130 does not exceed the reference differential pressure by the predetermined value, the controller 170 determines whether the differential pressure exceeds the reference differential pressure by less than the predetermined value (step 440). If the differential pressure exceeds the reference differential pressure by less than the predetermined value, the controller 170 doses the valves by using the dose model (step 450).

As mentioned above, the close model represents the current value at a time point at which the valves are closed according to the differential pressure between the master cylinder 110 and the wheel cylinder 130. In other words, the close model represents the current value at a time point at which the differential pressure, which is constantly maintained before, is increased as the valves are switched from the open state to the closed state.

In this manner, the controller 170 switches the valves from the open state into the closed state by using the dose model to reduce the pressure of the wheel cylinder such that differential pressure between the master cylinder and the wheel cylinder can be increased, thereby constantly maintaining the differential pressure.

Although few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for controlling a valve in an electronic hydraulic pressure control system, the method comprising:
measuring pressure of a master cylinder;
measuring pressure of a wheel cylinder; and
controlling on/off operation of the valve based on a current value obtained according to differential pressure between the master cylinder and the wheel cylinder.

2. The method as claimed in claim 1, wherein the valve is controlled such that the valve is open according to an open model when the differential pressure between the master cylinder and the wheel cylinder is higher than predetermined reference differential pressure by a predetermined value or more.

3. The method as claimed in claim 1, wherein the valve is controlled such that the valve is closed according to a dose model when the differential pressure between the master cylinder and the wheel cylinder is lower than predetermined reference differential pressure by a predetermined value or more.

4. The method as claimed in claim 2, wherein the open model represents a current value at a time point at which the valve is open according to the differential pressure between the master cylinder and the wheel cylinder.

5. The method as claimed in claim 3, wherein the close model represents a current value at a time point at which the valve is dosed according to the differential pressure between the master cylinder and the wheel cylinder.
